(19) United States
(12) Patent Application Publication
(10) Pub. No.: US 2003/0059053 A1
(43) Pub. Date: Mar. 27, 2003

(54) Key management interface to multiple and simultaneous protocols

(75) Inventors: Alexander Medvinsky, San Diego, CA (US); Petr Peterka, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation Motorola, Inc., Horsham, PA

(21) Appl. No.: 10/194,922

(22) Filed: Jul. 12, 2002

Related U.S. Application Data
(63) Continuation-in-part of application No. 09/966,552, filed on Sep. 26, 2001.

(51) Int. Cl. H04L 9/00

(52) U.S. Cl. 380/277

(57) ABSTRACT

A system and method for interfacing protocol applications with a daemon to perform secure key management between the a computer system and a second computer system. The method includes providing a first protocol application running on the first computer, and specifying an application role value from the first protocol application to the daemon, the application role for identifying the first protocol application. Further, the method includes specifying an object containing application data specific to the first protocol application, and employing the object and the application role value for performing key management in order to secure communication of real-time data between the first computer system and the second computer systems.

### CROSS-REFERENCES TO RELATED APPLICATIONS

This application is related to the following U.S. non-provisional applications, U.S. patent application Ser. No. 10/170,951, entitled “ACCESS CONTROL AND KEY MANAGEMENT SYSTEM FOR STREAMING MEDIA” filed Jun. 12, 2002 (Attorney Docket No. 018926-007700US); U.S. patent application Ser. No. 10/092,347, entitled “KEY MANAGEMENT PROTOCOL AND AUTHENTICATION SYSTEM FOR SECURE INTERNET PROTOCOL RIGHTS MANAGEMENT ARCHITECTURE” filed Mar. 4, 2002 (Attorney Docket No. 018926-007500US); U.S. patent application Ser. No. entitled “ENCRYPTION OF STREAMING CONTROL PROTOCOLS AND THEIR HEADERS TO PRESERVE ADDRESS POINTERS TO CONTENT AND PREVENT DENIAL OF SERVICE” filed Jun. 25, 2002 (Attorney Docket No. 018926-007900US); U.S. patent application Ser. No. 09/966,552, entitled “UNIQUE ON-LINE PROVISIONING OF USER SYSTEMS ALLOWING USER AUTHENTICATION” filed Sep. 26, 2001 (Attorney Docket No. 018926-007800US); and U.S. patent application Ser. No. 10/153,445, entitled “ASSOCIATION OF SECURITY PARAMETERS FOR A COLLECTION OF RELATED STREAMING PROTOCOLS” filed May 21, 2002 (Attorney Docket No. 018926-007600US), all of which are hereby incorporated by reference in their entirety as set forth in full in the present invention, for all purposes.

### BACKGROUND OF THE INVENTION

The present invention relates generally to the field of data communication and more specifically to rights management and securing data communicated in a network.

A growing interest in distribution of multimedia real-time data streams over Internet Protocol (IP) networks has resulted in a growing need for access control and key management systems.

One related art key management system developed at MIT is known as the Kerberos protocol. Kerberos is an authentication protocol allowing a party to access different machines on a network by using a KDC (key distribution center) and the concept of tickets. A ticket is used to securely pass to a server the identity of the client for whom the ticket was issued. One drawback of Kerberos is that it is relatively complex and can include many different options, which are not always applicable to particular applications. Moreover, modifying such a complex system is no option because such modifications to an unfamiliar system adds the risk of introducing additional errors. Another disadvantage of Kerberos is that the key management messages do not have sufficient information for the key exchange. The above-referenced U.S. patents commonly owned by the assignee of the present invention disclose a system for resolving some of the aforementioned problems.

Some existing key management systems provide a framework that allows the same key management to be applied to multiple protocols. For example, ISAKMP (Internet Security Association and Key Management Protocol) allows a single key management to be used with multiple protocols. In practice, however, it has been used only for IPSec(Internet Protocol Security) protocol.

Further, it is beneficial for the same key management system to interface with multiple network applications. For example, this technique is applied in the enforcement of authorization rights or access control. The same key management system, even when applied to a single protocol, for different key management exchanges may need to check authorization rights with different software (or hardware) modules.

Existing key management protocols can interface with multiple network applications only when each such network application is associated with a separate protocol. For example, PacketCable security allows a single key management protocol to provide both IP Security and SNMPv3 (Simple Network Management Protocol) security and can interface with separate IPSec and SNMPv3 modules for that purpose.

A drawback of existing key management systems is that they are unable to interface with multiple network applications when security is applied to a single protocol. A further disadvantage of existing key management systems is that each time they need to interface to a new network application, the key management system has to be modified (while this invention allows the same key management system to interface to any number of new applications without modification). The result is an increase in complexity of the overall architecture of conventional key management systems.

In some instances, attempts have been made to reduce complexity by utilizing separate versions of the same key management system to interface the distributed network applications. Such a solution however, is disadvantageous as it requires managing multiple key management systems which in any event may result in further complexity.

Therefore, there is a need to resolve one or more of the aforementioned problems and the present invention meets this need.

### BRIEF SUMMARY OF THE INVENTION

A first aspect of the present invention discloses a layered architecture for a key management system. The bottom layer of the architecture is a generic daemon that functions to communicate messages between a server and a client or peer to peer systems in a communication network. A daemon is a program that runs continuously on a computer system for the purpose of handling periodic messages that the computer system may receive. Such messages may be periodic service requests, for example.

These messages are communicated between a generic client daemon running on the client and a generic server daemon located on a remote server. When a first application, e.g., a streaming application on the client wishes to receive content from the server, it sends a message to the client daemon. This message includes an application role value that uniquely identifies each application.

In turn, the client daemon sends a key request message to the server daemon to perform secure key management. The server responds with cryptographic keys for streaming the contents from the server to the client. Similarly, when a second application, e.g., a provisioning application wishes to perform secure provisioning, it provides its application role value to the client daemon. The client daemon then establishes key management with the server daemon to obtain the necessary cryptographic keys.

Once obtained, these cryptographic keys are then distributed by the client daemon to the appropriate applications. Note that the correct applications are identified using the application role values previously passed to the client daemon. In this fashion, multiple applications with different functionalities may interface with the daemon to establish key management. That is, the, daemon functions as an intermediary to perform key management functions. Advantageously, the daemon need not be changed when new applications are developed except as necessary to accommodate the present invention.

According to another aspect of the present invention, a key management interface for interfacing with multiple protocols for performing secure key management is taught. The key management interface includes a first application for streaming real-time data, and a second application for provisioning real-time data. The interface further includes a daemon application for performing key management. This daemon interfaces with a remotely located daemon to secure cryptographic keys for securely streaming the real-time data and for provisioning of the real-time data. These keys are then passed to both the first and second applications.

Advantageously, the key management daemon is implemented once, and different application roles values may be provided as new applications are developed.

### BRIEF DESCRIPTION OF THE DRAWINGS

FIG. 1 is a block diagram of a network for facilitating streaming of content over a communication network.

FIG. 2 is a block diagram of an IPRM (Internet protocol rights management) system incorporating the ES Broker™ protocol for applying key management and security to the network of FIG. 1 in accordance with an exemplary embodiment of the present invention.

FIG. 3 is a high-level flow diagram of the security and key management protocol when key management is initiated by a consumer (client) to a caching server (server) in accordance with an exemplary embodiment of the present invention.

FIG. 4 is a high-level flow diagram of the security and key management protocol when key management is initiated from a caching server (server) to a content provider (client) in accordance with an exemplary embodiment of the present invention.

FIG. 5 is a block diagram illustrating initial registration and the receipt of content by a consumer in accordance with an exemplary embodiment of the present invention.

A further understanding of the nature and advantages of the present invention herein may be realized by reference to the remaining portions of the specification and the attached drawings. References to “steps” of the present invention should not be construed as limited to “step plus function” means, and is not intended to refer to a specific order for implementing the invention. Further features and advantages of the present invention, as well as the structure and operation of various embodiments of the present invention, are described in detail below with respect to the accompanying drawings. In the drawings, the same reference numbers indicate identical or functionally similar elements.

### DETAILED DESCRIPTION OF THE INVENTION

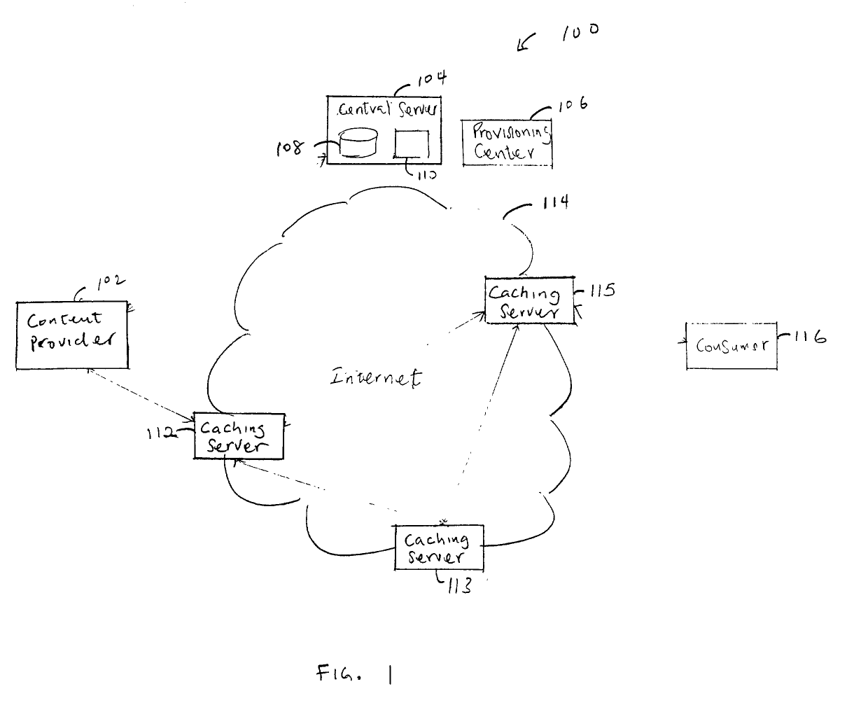

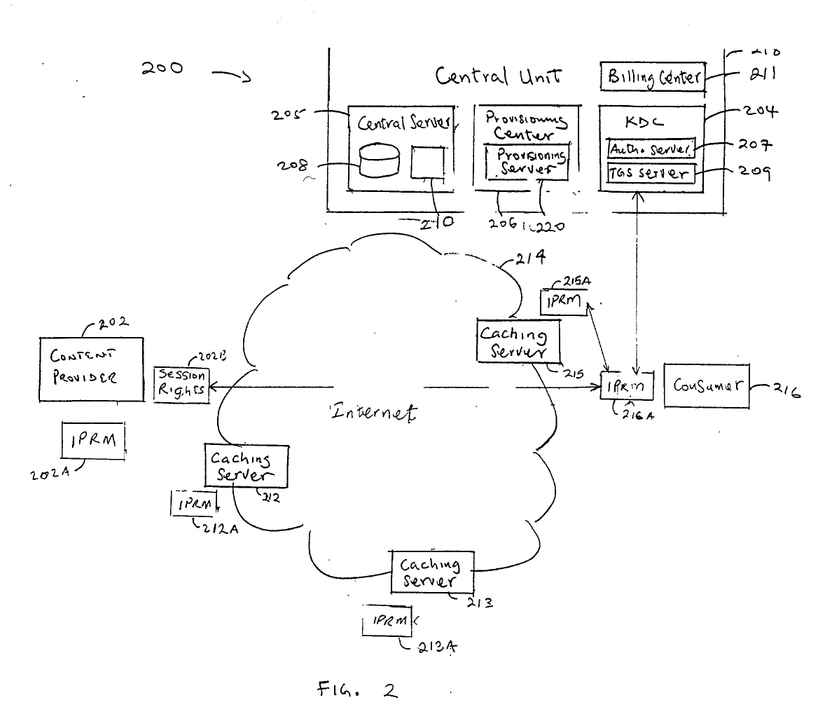

FIG. 2 is a block diagram of an IPRM (Internet protocol rights management) system 200 incorporating the ESBroker™ protocol for applying key management and security to network 100 of FIG. 1 in accordance with an exemplary embodiment of the present invention.

Among other components, IPRM system 200 comprises a content provider 202, consumer 216, Internet 214, a provisioning center 206, a central server 205 that contains both a database 208 and a search engine 210, caching servers 212, 213 and 215 all of which function in a similar manner to those of the corresponding components in FIG. 1. In addition, IPRM system 200 comprises a KDC (key distribution center) 204 containing an AS (authentication server) 207 for issuing a TGT (ticket granting ticket) to consumer 216, a TGS (ticket granting server) 209 for providing server tickets to access particular servers, a provisioning server 220, and a billing center 211. KDC 204, billing center 211, provisioning center 206 and central server 205 are all located within a central unit 218 for facilitating provision of services within IPRM system 200. As used herein, a ticket is an authentication token that is given out to a client by the KDC. Among other information, a ticket contains the name of the client, name of a specific server and a session key (a symmetric encryption key).

Further, IPRM system 200 contains an IPRM agent 202A for administering rights management for content provider 202, a session rights object 202B having user selections and optionally content access rules for content to be streamed, an IPRM agent 212A for administering rights management for caching server 212, IPRM agent 213A for administering rights management for caching server 213, IPRM agent 215A for administering rights management for caching server 215, IPRM agent 216A for administering rights management for consumer 216, and a viewer (not shown) within consumer 216 for receiving desired content. Although not shown, the foregoing components may be located within their associated components. For example, IPRM agent 202A is locatable within content provider 202 rather than externally as shown.

As noted, IPRM system 200 generally functions to facilitate streaming of content in a secure fashion, to consumer 216 by using caching servers 212, 213 and 215. Content provider 202 provides content only once and thereafter it can be moved among the caching servers. The reason for the caching servers are to move the content closer to the edges of IPRM system 200. This improves the streaming performance and allows smaller content providers to sell their content without the need to buy expensive hardware for media streaming. It also allows introduction of an IP multicast (communication between a single sender and multiple receivers on a network) only at the caching servers. With current technology it is easier to have an IP multicast limited to a local access network than to have an IP multicast over the Internet.

The present invention in accordance with a first embodiment provides security to IPRM system 200 via KDC 204, IPRM agents 202A, 212A, 213A, 215A, and 216A. The IPRM agents in conjunction with KDC 204 and provisioning center 206 provide authentication, privacy, integrity and access control tools to all aspects of IPRM system 200. For example, before a consumer can utilize the system for streaming content, a registration process is required. Secure registration for the consumer is provided by IPRM system 200. Thus, during the registration process, no one else may replicate the identity of consumer 216 by intercepting messages between consumer 216 and KDC 204. KDC 204 is a trusted entity and provides key distribution to network components using a blend of symmetric and asymmetric algorithms.

KDC 204 and the IPRM components may be purely software protection, with a limited trust placed upon consumer 216s, or may be hardware security modules, which may be mandatory to obtain rights to high quality content from copyright owners requiring high security levels, or may be a combination of both software and hardware. IPRM uses an authenticated key management protocol with high scalability to millions of consumers. The key management protocol is called ESBrokerrm (Electronic Security Broker), a product of Motorola, Inc., San Diego, Calif., will be referenced throughout this specification.

The ESBroker™ protocol partly based on the Kerberos framework consists of client interactions with the centralized Key Distribution Center (KDC 204) as well as with the individual application servers. A KDC client is any host that can send requests to the KDC. Within the IPRM system this includes consumers, caching servers and other IPRM system components. An application server is any server registered with the KDC for which a client might request a service ticket (e.g. caching server, Billing Center, etc.). The same host may be both a KDC client and an application server at the same time. For the IPRM system 200, the protocol employs a series of messages to accomplish key management between client and server interfaces of the system. This key management protocol is intended to be of general use for establishing secure sessions and is not restricted to the IPRM system. These messages listed in Table 1 below, are further described in the section entitled IPRM Protocol Messages.

TABLE 1

| Code | Message Type | Description |
|---|---|---|
| 1 | CLIENT_ENROLL_REQ | Client enrollment request, containing client public |
| | | key and other attributes |
| 2 | CLIENT_ENROLL_REP | Client enrollment reply from KDC 204, possibly |
| | | containing a client certificate for the public key. |
| 3 | AS_REQ | Request Ticket Granting, Ticket from the |
| | | Authentication Server |
| 4 | AS_REP | Reply from Authentication Server with the TGT |
| 5 | TGS_REQ | Request service ticket from TGS server 209 |
| 6 | TGS_REP | Reply from TGS server 209 with the service ticket |
| 7 | TKT_CHALLENGE | Server requests this client to initiate key management |
| 8 | KEY_REQ | Key Management request from client |
| 9 | KEY_REP | Key Management reply from the application server |
| 10 | SEC_ESTABLISHED | An ACK from client to an application server stating |
| | | that security is established |
| 11 | ESB_ERR | Error reply message |
| 12 | INIT_PRINCIPAL_REQ | Create a Provisioning Ticket for a specified |
| | | principal. If the specified principal doesn't already |
| | | exist, it will be initialized in KDC 204 database. |
| 13 | INIT_PRINCIPAL_REP | Returns a Provisioning Ticket for the specified |
| | | principal. |
| 14 | DELETE_PRINCIPAL_REQ | Delete a specified ESBroker ™ principal from KDC |
| | | 204 database. |
| 15 | DELETE_PRINCIPAL_REP | Acknowledgment to DELETE_PRINCIPAL_REQ |
| 16 | SERVICE_KEY_REQ | Application server requests a new service key from |
| | | KDC 204. |
| 17 | SERVICE_KEY_REP | KDC 204 returns a new service key to the |
| | | application server. |
| 18 | AUTH_DATA_REQ | KDC 204 requests authorization data for a particular |
| | | principal. This may be part or all of the |
| | | authorization data that will appear in a ticket that |
| | | KDC 204 subsequently issues. |
| 19 | AUTH_DATA_REP | Authorization Server returns the data requested with |
| | | AUTH_DATA_REQ. |

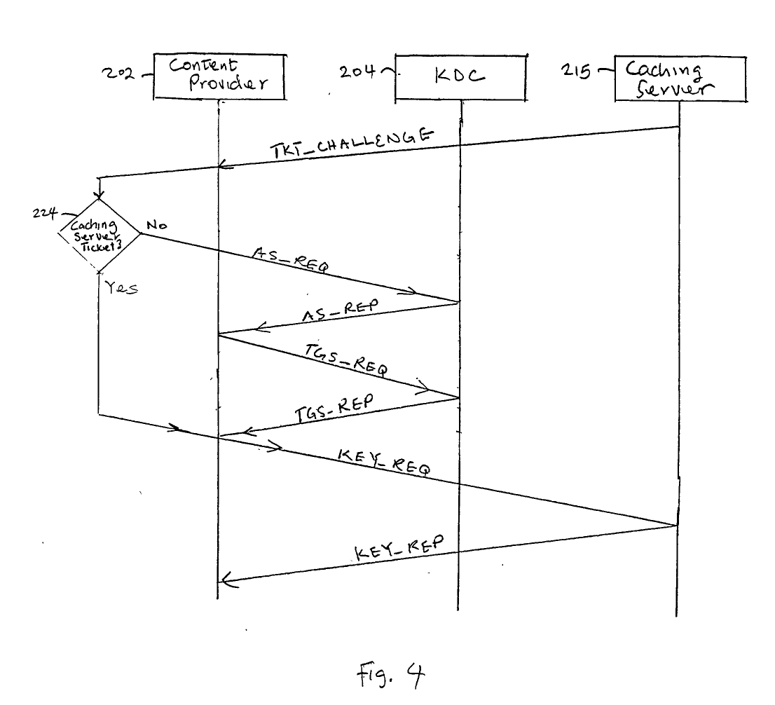

In operation, the key management process between a client and a server is classified two phases: (1) a generic phase in which a client is in contact with KDC 204 to obtain a server ticket to access the server; and (2) a non-generic phase in which the client uses the server ticket to form a KEY_REQ (key request) message to the server. In the non-generic phase, a DOI (domain of interpretation) object containing information that is specific to a particular application of a general ESBroker key management protocol (e.g. specifically for the IPRM System). For example, in a key management process between consumer 216 (client) and caching server 215 (server), the generic phase involves obtaining, by consumer 216, a server ticket from KDC 204 for accessing caching server 215. The non-generic process involves using the server ticket to generate the KEY_REQ message for accessing caching server 215, wherein the KEY_REQ contains the DOI object that contains the Session Rights. Furthermore, which messages are used in the protocol depend on whether key management is client or server initiated. If server initiated, the TKT_CHALLENGE (ticket challenge) message is employed in addition to other messages as more clearly shown with reference to FIG. 4.

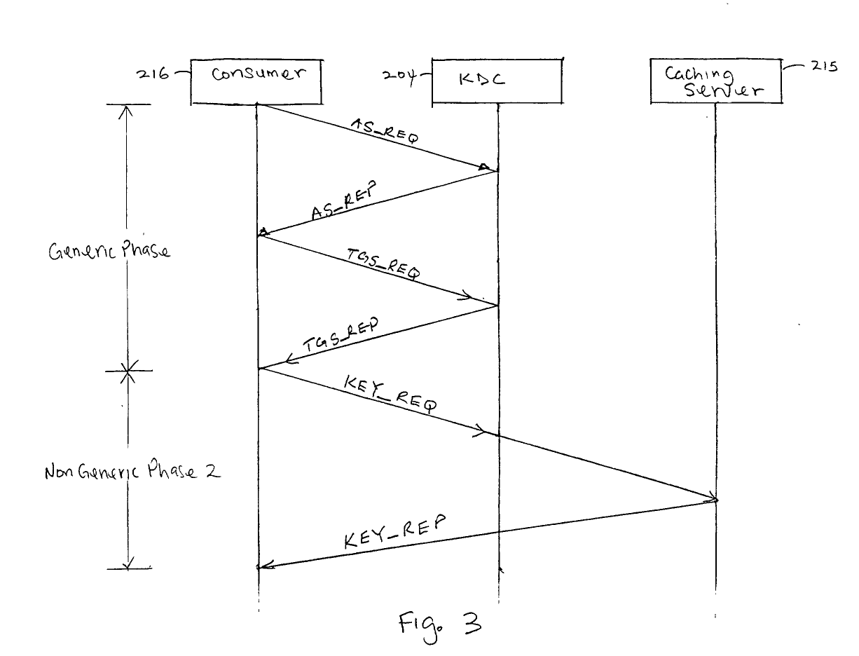

FIG. 3 is a high-level flow diagram of the security and key management protocol when key management is initiated by consumer 216 (client) to caching server 215 (server) in accordance with an exemplary embodiment of the present invention.

As shown, consumer 216 wishing to stream content from caching server 215 in a secure manner initiates the key management process. This is done by transmitting an AS_REQ message to KDC 204 to obtain a TGT (ticket granting ticket) for TG server 209. The AS_REQ message contains the consumer 216's identity, KDC 204's identity, more specifically the KDC realm or administrative domain, and a nonce to tie it to a response. It may also contain a list of symmetric encryption algorithms that are supported by consumer 216. Of course, it is assumed that both consumer 216 and caching server 215 have been registered by KDC 204 which acts as a trusted authenticator and can verify the identity of both nodes.

As shown, in response to the AS_REQ message, KDC 204 validates the TGT request, checks with provisioning server 220 for validity of consumer 216 and thereafter responds with an AS_REP message containing the TGT. It should be noted that the private portion of the TGT is encrypted with KDC 204's service key known only to KDC 204. The same KDC 204 service key is also used to authenticate the TGT with a keyed hash. Since consumer 216 does not know KDC 204 service key, it cannot modify it and cannot read the private part of the ticket. Because consumer 216 still needs to know the session key for subsequent authentication to KDC 204, another copy of the session key is delivered to consumer 216 using a key agreement algorithm (e.g., Elliptic Curve Diffie-Hellman).

After receiving and storing the TGT, consumer 216 is ready to start requesting streaming content on this network. A TGS_REQ message containing the TGT is sent to KDC 204 (TGS server 209) requesting a ticket for caching server 215. It should be noted that consumer 216 might perform additional provisioning actions, such as subscribe to a particular content provider. Also, consumer 216 may create a list of preferred caching servers.

Responsive to the TGS_REQ message, a TGS_REP message having the caching server ticket is transmitted to consumer 216 from KDC 204. If there are additional preferred caching servers, consumer 216 may contact KDC 204 to obtain caching server tickets for the preferred caching servers using the TGT. These caching server tickets may then be cached for later use. Otherwise, the caching server tickets are obtained at the time of requesting the content from the appropriate caching server.

For some consumers, KDC 204 first needs to query provisioning server 220 for subscriber authorization data before issuing the caching server tickets. This is accomplished with an AUTH_DATA_REQ/AUTH_DATA_REP exchange between KDC 204 and the provisioning server 220. The user authorization data is insertable into the tickets. The caching server ticket has the same format as the TGT—it includes a session key used for authentication to the caching server 215. The private part of the ticket is encrypted with caching server 215's service key known only to it and KDC 204. The ticket is also authenticated with a hash that is keyed with the same service key. As is the case with the TGT, consumer 216 is not able to modify this ticket. Consumer 216 needs the session key from the caching server ticket to authenticate itself to this server. A copy of this session key is delivered to consumer 216, encrypted with the TGT session key.

This process beginning with the AS_REQ message to the TGS_REP message corresponds to the generic phase noted above wherein a client is in contact with KDC 204 to obtain a server ticket to access the server. Because it is generic, the same process is used to secure other interfaces for delivery of content from content provider to caching servers; reporting of usage; billing, etc. Further, this results in a more secure IPRM system without the need for unnecessary or complex options. Moreover, because of the reduction in complexity, problems are identified and rectified in an expeditious fashion.

Upon receiving the TGS_REP message containing the caching server ticket, a KEY_REQ message with the ticket is sent to caching server 215. The KEY_REQ message contains a MAC (message authentication code) of the message, DOI (domain of interpretation) object and a time stamp in addition to the caching server ticket. A DOI object is for carrying application specific information_associated with this secure session. In the present embodiment, the DOI object contains session rights information for consumer 216. The reason for encapsulating the session rights into this DOI object is because the session rights are specific to this particular content delivery architecture (with caching servers), while the ESBroker protocol provides generic key management services. ESBroker could be applied to other types of secure sessions, with their application-specific information also encapsulated in the DOI object.

When caching server 215 receives the generic KEY_REQ message, it extracts the non-generic DOI object. Caching server 215 then checks application specific code for streaming, for example, verifies the DOI object, and authorization information. If the session rights matches the authorization data in the ticket, a KEY_REP message containing a session key is forwarded to consumer 216. From that point, both sides have a protocol key and can start encrypting their final messages such as streaming content. If authorization fails, an error message is forwarded to the consumer. It should be noted that in some instances, the KEY_REP message contains a generic DOI object where caching server 215 needs to return some application specific information to consumer 216. For example, in the IPRM system, when the caching server sends a Ticket Challenge to the content provider to request a secure session, the session ID is provided later by the caching server, inside the DOI object in the KEY_REP message. The Ticket Challenge message is not authenticated and therefore does not contain a DOI object.

This phase (KEY_REQ/KEY_REP) corresponds to the non-generic phase in which the client uses the server ticket to form a key request to the server. This phase is non-generic because the DOI object varies depending on the interface being secured. For example, the DOI object relating to delivery of content from content provider to caching servers is different from that employed for delivery of the same content from a caching server to subscribers.

FIG. 4 is a high-level flow diagram of the security and key management protocol when key management is initiated from caching server 215 (server) to content provider 202 (client) in accordance with an exemplary embodiment of the present invention.

Key management is initiated by caching server 215 when a request for content is received and caching server 215 does not have the requested content. As shown, key management is initiated by sending a TKT_CHALLENGE (ticket challenge) message from the caching server 215 to content provider 202. The TKT_CHALLENGE is for use by a server to direct a client to initiate key management.

At decision block 224, if content provider 202 has a previously obtained caching server ticket, it forwards a KEY_REQ message containing the ticket to caching server 215. In response, caching server 215 sends a KEY_REP message as previously discussed above. On the other hand, returning to decision block 224, if content provider 202 has no caching server ticket and no TGT, it sends an AS_REQ message to KDC 204 which replies with an AS_REP message. If the content provider has its TGT the AS_REQ/REP is skipped.

Thereafter, content provider 202 sends a TGS_REQ message to KDC 204, and receives a TGS_REP message containing the caching server ticket. When the caching ticket is obtained, content provider 202 sends a KEY_REQ message in this case with no DOI object, since the session ID is included in the KEY_REP. Alternatively, the content provider could also generate the session ID and include it in the DOI object in the KEY_REQ message. Session rights don't apply since neither content provider 202 nor caching server 215 is a consumer. Once the shared key is established, SEC_ESTABLISHED message (not shown) is sent to caching server 215 by content provider 202. Since the server initiated key management, the SEC_ESTABLISHED message informs the server that security has been established.

Advantageously, it should be observed that the same messages namely TKT_CHALLENGE, AS_REQ/AS_REP, TGS₁₃ REQ/TGS_REP, KEY_REQ/KEY_REP, SECURITY_ESTABLISHED are used in multiple protocols and scenarios depending on whether a client or server initiates key management. If the server requests key management, all of the messages are used including the TKT_CHALLENGE message. Contrawise, if the client initiates key management all messages other than the TKT_CHALLENGE are employed. It should be observed that the Security Established message is also commonly skipped when client initiates key management. Advantageously, because a single key management protocol is utilized on all interfaces, it is easier to analyze whether the system is secure. In addition, the system secures both streaming content and non-streaming content including billing data with the same key management with changes only to the DOI object field.

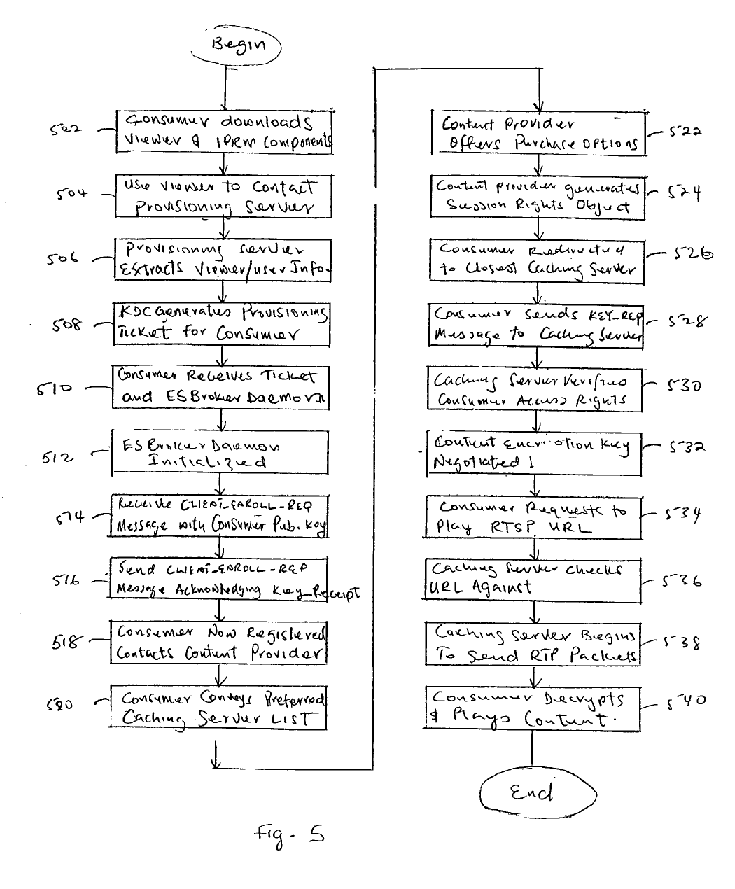

FIG. 5 is a block diagram illustrating initial registration and the receipt of content by consumer 216 in accordance with an exemplary embodiment of the present invention.

A new consumer 216 wishing to receive content from caching server 215 may initially sign up with central unit 218.

At block 502, consumer 216 using a web browser accesses a web site (not shown) provided by central unit 218. Consumer 216 comes to the initial sign-up and software download page, downloads and installs a viewer application, including any IPRM components. Alternatively, the viewer application and IPRM components could be distributed to consumers with removable media, such as a CD-ROM.

At block 504, consumer 216 starts up the viewer to initiate an SSL (secured socket layer) session with provisioning server 220. The session is initiated using a central unit 218 certificate (not shown). The certificate is the signed public key of the central unit 218 previously obtained by consumer 216. After the SSL session begins, consumer 216 fills out the initial signup form, which includes a form for a user ID. Or, the user ID can be automatically assigned by the central unit. Consumer 216 next determines a local host identifier and sends it to provisioning server 220 along with other information. (This is done transparently by the viewer).

At block 506, provisioning server 220 extracts the user ID and converts it to an ESBroker™ principal name. A principal name is a uniquely named consumer or server instance that participates in IPRM system 200. In this case, the viewer principal name is the same as a subscriber id assigned to that viewer. After the user ID is converted to an ESBroker™ principal name, provisioning server 220 sends a command to KDC 204 to generate a new ESBroker™ principal in KDC 204 database (not shown). This command also includes a consumer 216 host identifier.

At block 508, KDC 204 generates a provisioning ticket containing a provisioning key (session key) for consumer 216. The provisioning key may be a symmetric key in one embodiment of the present invention. The provisioning key is used by KDC 204 for authentication of messages between itself and consumer 216. Thereafter, the provisioning ticket is returned to provisioning server 220 along with an SKS (Session Key Seed). Because consumer 216 has no access to the provisioning key (encrypted with a KDC 204 key), the SKS is used by consumer 216 to reconstruct the provisioning key located within the provisioning ticket.

At block 510, in addition to the provisioning ticket, configuration parameters including the user ID, ticket expiration time (already included in the non-encrypted part of the ticket), KDC 204 name and/or address etc. and (optionally) software components including an ESBroker™ daemon are downloaded by consumer 216. It should be observed that the software components might have been downloaded previous to this registration procedure, as is the case in the Aerocast network.) Thereafter, the SSL connection is terminated.

At block 512, the ESBroker™ daemon is initialized using the downloaded configuration parameters.

At block 514, a public/private key pair for authenticating AS_REQ messages between consumer 216 and KDC 204 is generated. The public key is forwarded to KDC 204 from consumer 216. This is accomplished using a CLIENT_ENROLL_REQ message. The message contains the public key (symmetrically) signed with the provisioning key derived from the SKS by consumer 216. Since there is no access to the provisioning key within the provisioning ticket, consumer 216 derives the provisioning key from the SKS using a one-way function. The problem with distributing tickets and provisioning keys to software clients is that a software client may copy the ticket and key for forwarding to an unauthorized software client. To address this problem, consumer 216 receives the SKS instead of the actual provisioning key. Combining SKS with a unique host identifier using a one-way function generates the provisioning key. The SKS is specific to a particular host and can't be used anywhere else. In the present embodiment, consumer 216 executes the following function to reproduce the provisioning key:

Provisioning key=SKGen (Host ID, SKS)

Where SKGen ( ) is a one-way function; SKGen⁻¹ ( ) cannot be calculated within reasonable amount of time (e.g. in less than the ticket lifetime).

At block 516, upon receiving the CLIENT_ENROLL_REQ message, KDC 204 finds consumer 216 in its local database to verify the request. If the request is valid, KDC 204 stores the public key either in a client database that could be located locally on the KDC or at some other remote location with secure access. Alternatively, KDC 204 may generate a certificate with the public key for forwarding to consumer 216. A message CLIENT_ENROLL_REP acknowledging the key has been stored (or alternatively containing a client certificate) is then forwarded to consumer 216.

At block 518, consumer 216 is now enrolled and may contact a web site (not shown) with a database 208 having a listing of content from various providers including content provider 202. When the desired content is located, consumer 216 gets redirected to content provider 202.

At block 520, consumer 216 then contacts content provider 202 to which it was redirected and conveys its preferred list of caching servers, list of subscribed services, its ability to pay for content, etc.

At block 522, content provider 202 offers an optimized subset of purchase options that depend upon the context of the particular consumer and service. For example, price selection screens may be bypassed for consumers already subscribed to this service.

At block 524, content provider 202 generates a session rights object that encapsulates the purchase options selected by consumer 216, an optional set of content access rules (e.g., blackout regions) and a reference to the selected content. For example, a session ID which is a random number that was generated by consumer 216 when it requested these session sights from the content provider. An End Time after which these session rights are no longer valid, a ProviderID, PurchaseOption selected by consumer 216, etc.

At block 526, content provider 202 redirects consumer 216 to the appropriate caching server. In this case, content will be streamed from caching server 215 which is closest to consumer 216. If consumer 216 had previously cached a caching server ticket for caching server 215 when it signed up, it retrieves that ticket. If it has no cached ticket, it contacts KDC 204 using a TGT to obtain the correct caching server ticket.

At block 528, consumer 216 authenticates itself to caching server 215 using the caching server ticket, and at the same time (in the same KEY_REQ message) forwards the session rights object obtained from content provider 202 to caching server 215. Communication between consumer 216 and caching server 215 is accomplished using the KEY_REQ/KEY_REP messages, above.

At block 530, caching server 215 checks the access rules from the session rights object against consumer 216's entitlements contained in the ticket and also against the user selection (purchase option selected by the consumer) in the session rights object The entitlements are basically authorization data specific to consumer 216 which allows access to content. The set of content access rules is optional because it might have been delivered directly to caching server 215 with the content. Furthermore, caching server 215 can optionally gather additional content access rules from multiple sources. For example, an access network provider (e.g. cable system operator) might impose some restrictions for delivery over its network.

At block 532, if access is approved, consumer 216 and caching server 215 negotiate a Content Encryption Key (CEK) for delivery of the content.

At block 534, security parameters for securing communications during the streaming session are established. Among other parameters, the security parameters include MAC (message authentication code) and content encryption keys, the derivation of which is discussed under “Key Derivation,” below. A session identifier associated with the security parameters is also established. When consumer 216 starts issuing RTSP commands to the caching server 215 to get description of the content (RTSP URL), and to request to play the content, the RTSP message is secured with the security parameters.

At block 536, caching server 215 receives RTSP commands, decodes them and returns encrypted RTSP responses. When an RTSP command requests to play a specific URL, caching server 215 verifies that the specified URL is what was specified in the session rights object for this secure session, identified by the Session identifier.

At block 538, after receiving a request to play an RTSP URL, caching server 215 establishes a streaming session and begins to send out RTP packets. Both caching server 215 and consumer 216 periodically send RTCP report packets. All RTP and RTCP packets are encrypted with the security parameters. Further, the RTP and RTCP packets associated with the same RTSP URL are encrypted using the same Session ID, the Session ID that was recorded when caching server 215 started receiving encrypted RTSP messages from consumer 216. It should be observed that the RTSP, RTP and RTCP messages may be exchanged in any order, each message being secured with the security parameters which are identifiable with the session identifier.

At block 540, consumer 216 decrypts and plays the content. At the same time, consumer 216 may issue additional RTSP commands (e.g. to pause or resume content play out), still encrypted using the same Session ID. Caching server 215 keeps track of who viewed the content, how long the content was viewed, and under what mechanism the content was purchased.

Streaming and Non-Streaming Content

There are two basic categories of content that are protected: streaming and non-streaming content. The following protocols are used to deliver either the actual streaming content or information related to the content: RTP (real time protocol)/RTCP (real time control protocol), RTSP (real time streaming protocol). Streaming Description: RTSP with SDP (session description protocol). Other Non-Streaming Content: RTCP, HTTP (provisioning, content publishing to the directory); Custom protocols over either TCP (transport control protocol) or UDP (user datagram protocol) (content usage reporting). Streaming Content: in standards-based systems, the streaming content is typically delivered using the RTP. There are additional proprietary streaming protocols such as Real and Microsoft's Windows Media that may be employed.

Key Derivation

This key derivation procedure is specific to the IPRM DOI_ID value and is applicable to media streams as well as other target protocols that fall under the same DOI_ID. After the Target Application Secret (TAS) (a concatenation of the ESBroker™ session key and the subkey) has been established with key management, it is used to derive the following set of keys in the specified order. A client (that generated an ESBroker™ KEY_REQ message) derives:

Outbound EK, content encryption key for outbound messages. The length is dependent on the selected cipher.

Outbound K_{MAC}, a MAC (Message Authentication Code) key used in the generation of a MAC for authenticating outbound messages. The key length is dependent on the selected message authentication algorithm.

Inbound EK, content encryption key for inbound messages.

Inbound K_{MAC}, a MAC key used for authenticating inbound messages.

An application server (that generated an ESBroker™ Key Reply message) derives:

Inbound EK

Inbound K_{MAC}

Outbound EK

Outbound K_{MAC}

Note that the derivation order of the inbound and outbound keys at the client and server are reversed—this is because the same key used to encrypt outbound traffic on one side is used to decrypt inbound traffic on the other side. Similarly, a MAC key used to generate MACs for outbound messages on one side is used to verify the MAC values on inbound messages on the other side.

Note that not all the keys are used for each protocol. For example, RTP only uses EK, the encryption key, and only for one direction of traffic—because within IPRM there are no two-way RTP sessions (clients don't send RTP packets back to streaming servers).

IPRM Agent Architecture

Referring to FIG. 2, each IPRM agent includes a process referred to as ESBroker daemon. This daemon is a key management system that runs both on the server side and the client side. Identical ESBroker daemons are running on IPRM 216A, IPRM 212A of consumer 216, and caching server 212, respectively. ESBroker daemon interfaces with the various applications such as streaming, billing, reporting, and secure provisioning applications, for example. The secure provisioning application secures end-to-end connections for the communication network.

Initially, each application registers with the ESBroker daemon by specifying its application role. This application role serves as a parameter that uniquely identifies the application. For example, an application for streaming between servers may specify “streaming between servers,” as its application role. Another application may specify “streaming to a subscriber” while a billing application indicates a “billing” application role. Other applications such as reporting, and secure provisioning may specify their roles as well.

The layered architecture of the present invention is implemented on both the client and the server sides, each side having identical layers. Although each application has differing functions, they interface with a single ESBroker daemon interface.

Consumer 216 wishing to securely stream content, initiates the streaming application (not shown) via a user interface or transparently), for example. The streaming application in turn requests key management from the client ESBroker daemon to secure the streaming session. One of ordinary skill in the art will realize that the ESBroker daemon may be any key management process consistent with the spirit and scope of the present invention. In its key request, the streaming application specifies its application role value, namely “streaming to subscriber” and a DOI object containing application specific information. The DOI object contains session rights for consumer 216, the session rights being provided by content provider 202 (as previously discussed).

It should be observed that the client ESBroker daemon is not a streaming application and knows nothing about streaming. It sets up keys but cannot process other auxiliary information. In this manner, the ESBroker daemon need not be rewritten when new applications are added. Furthermore, ESBroker daemon has no idea how to interpret and enforce the streaming session rights—this is the job of an application that is external to ESBroker. Thus, any changes to the session rights would not require corresponding changes to the ESBroker daemon.

After the key management request is received, the client ESBroker daemon retrieves the specified values to form a Key_Request message requesting session keys from caching server 212. Specifically, the Key_Request message is delivered to a server ESBroker daemon (IPRM 212A of caching server 212) that thereafter examines the application role. A list of registered applications is searched to determine which application corresponds to the specified application role value, in this case for “streaming to subscriber”. It is this streaming application to which the DOI object is passed to for processing. As noted, the DOI object specifies session rights for streaming between consumer 216 and caching server 212. Upon receiving the DOI object, the streaming application verifies the session rights and returns either an approval or error code to the server ESBroker daemon, which forwards the result to the client ESBroker daemon via a Key_Reply message.

The same process is followed when other applications and protocols require key management within the communication system. For example, secure provisioning application interfaces with the ESBroker daemon and communicates with the provisioning server to secure HTTP. In this case, the protocol being secured is not a streaming protocol but rather HTTP. HTTP requires security when user information via the provisioning server 220 is to be modified.

Thus, advantageously, a layered architecture of the key management where the bottom layer is the generic ESBroker daemon that only functions to communicate key request/reply messages. In this fashion, the ESBroker daemon need not be changed (except to accommodate necessary modifications). Different values of DOI objects and application roles can be plugged in such that various applications can register and are able interpret the values for the specific application. The protocol is implemented once, and different application roles and values and DOI objects are plugged in as new applications are developed.

While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A key management interface system for interfacing with multiple protocols to perform secure key management, the key management interface system comprising:
one or more applications comprising,
a first application for streaming real-time data;
a second application for provisioning real-time data;
a daemon for performing key management, the daemon interfacing with the first application to secure cryptographic keys for securely streaming the real-time data; and
the daemon interfacing with the second application to secure cryptographic keys for secure provisioning of the real-time data.

2. The interface system of claim 1 wherein the first application comprises one or more software instructions for specifying an application role value, the application role value for uniquely identifying the first application.

3. In a communication system having a daemon running on a first computer, a method for interfacing protocol applications with the daemon to perform secure key management, the method comprising:
providing a first protocol application running on the first computer;
specifying a role value for identifying the first protocol application;
specifying an object containing application data specific to the first protocol application; and
using the object and the application role value for performing key management in order to secure communication of real-time data.

4. The method of claim 3 wherein the daemon is a client daemon, and the method further comprises
sending a key request message to a second computer, the key request message having the role value and the object.

5. The method of claim 4 further comprising
providing a server daemon on the second computer;
receiving the key request message containing the role value and the object;
identifying a third protocol application by using the role value and
forwarding the object to the third protocol application.

6. The method of claim 5 wherein the object contains session rights for accessing the real-time data stream.

7. The method of claim 5 further comprising
validating the session rights;
forwarding a response to the server daemon based on the validation; and
forwarding a key reply message to the client daemon, the key reply message containing the response.

8. The method of claim 3 further comprising
providing a second protocol application running on the first computer system;
specifying an application role value for identifying the second protocol application;
specifying an object containing application data specific to the second protocol application; and
employing the object and the application role value for performing key management in order to secure communication of real-time data between the first and second computer systems.

9. A key management interface for interfacing with multiple to securely transfer real-time data, the key management interface comprising:
a first computer system further comprising
a first protocol application;
a second protocol application;
a daemon for performing key management;
upon request for key management from the first protocol application, the daemon interfaces with the first protocol application to perform a first function relating to secure transfer of the real-time data; and
upon request for key management from the second protocol application, the daemon interfaces with the second protocol application to perform a second function relating to secure transfer of the real-time data.

10. The interface of claim 9 wherein the first function is for streaming the real-time data between the first computer system and a second computer system; and the second function is for performing provisioning relating to the real-time data.

11. The interface of claim 9 wherein upon start-up the first and the second protocol applications register with the daemon.

12. The interface of claim 9 wherein the first protocol specifies to the daemon an application role value for identifying the first protocol.

13. The method of claim 3 wherein the daemon is a peer daemon, the method further comprising
forwarding a key request message to the second computer, the key request message containing the application role value and the object.

14. The method of claim 4 further comprising
providing a peer daemon on the second computer;
receiving, by the peer daemon, the key request message containing the application role value and the object; and
forwarding the object to the third protocol application corresponding to the application role value.

15. The system of claim 1 further comprising
one or more software instructions for specifying an object having application data specific to the first application.

16. A key management interface system comprising:
a first computer system further comprising
a first protocol application;
a second protocol application; and
a daemon for performing key management;
upon request, the daemon interfaces with the first protocol application and the second protocol application to perform at least one key management function.

17. The interface system of claim 16 further comprising a role value for identifying the first protocol application; and
an object containing application data specific to the first protocol application, wherein the object and the application role value perform key management in order to secure communication of real-time data.
